(19) United States
(12) Patent Application Publication
(10) Pub. No.: US 2024/0056894 A1
(43) Pub. Date: Feb. 15, 2024

(54) DIGITAL RADIO COMMUNICATIONS

(71) Applicant: Nordic Semiconductor ASA, Trondheim (NO)

(72) Inventor: Pål HÅLAND, Trondheim (NO)

(73) Assignee: Nordic Semiconductor ASA, Trondheim (NO)

(21) Appl. No.: 18/267,080

(22) PCT Filed: Dec. 20, 2021
(86) PCT No.: PCT/EP2021/086879

§ 371 Date: Jun. 13, 2023

(30) Foreign Application Priority Data
Dec. 18, 2020 (GB) 2020110.9

(51) Int. Cl. H04W 28/18

(52) U.S. Cl. CPC H04W 28/18

(57) ABSTRACT

A digital radio transmitter device operates in accordance with a predetermined communication protocol that defines a default inter-frame spacing. The device has a minimum inter-frame spacing that is shorter than said default inter-frame spacing. The device is configured to: transmit a first data packet indicating that the device is able to support an inter-frame spacing shorter than said default inter-frame spacing; receive a second data packet from a peer device after said default inter-frame spacing; if said second data packet indicates that said peer device is able to support an inter-frame spacing shorter than said default inter-frame spacing, transmit a third data packet using an inter-frame spacing shorter than said default inter-frame spacing; and if said second data packet does not indicate that said peer device is able to support an inter-frame spacing shorter than said default inter-frame spacing, transmit said third packet using said default inter-frame spacing.

### FIELD

This invention relates to short-range, ad hoc radio communication networks. Such networks, which include for example Bluetooth™, have many uses for transferring data between, and controlling, a whole variety of different devices.

### BACKGROUND

In two-way digital radio communications, devices must regularly switch between transmission and reception in order to send and receive packets according to a particular radio protocol (typically known as half-duplex). In practice a finite time is required for a device to switch modes—e.g. to allow oscillators to stabilise etc, Radio protocols typically therefore specify an InterFrame Spacing (IFS) which is the minimum period of time between device transmitting a packet and being able to receive a packet or vice versa.

Under the Bluetooth™ protocol as it stands at the time of filing, the IFS is specified as 150 μS. This means that to be compatible with Bluetooth™ a device must be able to switch modes within that time. Conversely it means that the device cannot transmit a packet until at least 150 μS from receiving one.

### SUMMARY

When viewed from a first aspect the present invention provides a method of operating a digital radio transmitter device in accordance with a predetermined communication protocol defining a default inter-frame spacing, the device having a minimum inter-frame spacing shorter than said default inter-frame spacing, the method comprising:
transmitting a first data packet indicating that the device is able to support an inter-frame spacing shorter than said default inter-frame spacing;
receiving a second data packet from a peer device after said default inter-frame spacing;
if said second data packet indicates that said peer device is able to support an inter-frame spacing shorter than said default inter-frame spacing, transmitting a third data packet using an inter-frame spacing shorter than said default inter-frame spacing; and
if said second data packet does not indicate that said peer device is able to support an inter-frame spacing shorter than said default inter-frame spacing, transmitting said third packet using said default inter-frame spacing.

The invention extends to a computer readable medium comprising instructions configured to cause a digital radio transmitter device to operate in accordance with the method set forth above.

The invention also extends to a digital radio transmitter device configured to operate in accordance with a predetermined communication protocol defining a default inter-frame spacing, the device having a minimum inter-frame spacing shorter than said default inter-frame spacing, wherein the device is configured to:
transmit a first data packet indicating that the device is able to support an inter-frame spacing shorter than said default inter-frame spacing;
receive a second data packet from a peer device after said default inter-frame spacing;
if said second data packet indicates that said peer device is able to support an inter-frame spacing shorter than said default inter-frame spacing, transmit a third data packet using an inter-frame spacing shorter than said default inter-frame spacing; and
if said second data packet does not indicate that said peer device is able to support an inter-frame spacing shorter than said default inter-frame spacing, transmit said third packet using said default inter-frame spacing.

Thus it will be seen by those skilled in the art that in accordance with the present invention where two devices are each capable of supporting an inter-frame spacing (IFS) which is shorter than the IFS specified in the protocol, they can agree to communicate using the shorter IFS whilst still remaining compliant with the protocol. This is beneficial as it may allow a greater number of packets to be exchanged in a given time and thus may increase the effective data rate. On the other hand, a device operating in accordance with the invention is still compatible with devices which either cannot support a lower IFS or do not have the ability to negotiate a shorter IFS in accordance with the invention.

If said second data packet does not indicate a peer inter-frame spacing shorter than said default inter-frame spacing this may be because it does not indicate a peer inter-frame spacing at all—e.g. because it is a legacy device which does not support IFS negotiation)—or because it indicates positively that it does not support IFS negotiation, or simply because it cannot operate with a shorter IFS.

The first data packet could simply indicate an ability to support a predetermined shorter IFS. In a set of embodiments however the first data packet comprises information relating to said minimum IFS— i.e. the shortest IFS that the device can support. This may provide a peer device with a better idea of what the device is able to support without it necessarily needing to be defined in the protocol and thus increases the flexibility of this approach.

The second data packet could simply indicate acceptance or rejection of the indication in the first data packet. In a set of embodiments however the second data packet indicates a peer inter-frame spacing shorter than said default inter-frame spacing—i.e. the shortest IFS that the peer device can support. This may provide the device with a better idea of what the peer device is able to support without it necessarily needing to be defined in the protocol and thus also increases the flexibility of this approach. Where both devices indicate the shortest inter-frame spacing they are able to support, a selection of the optimum value can be made that is suitable for both devices. Thus in a further set of embodiments the method comprises:
if said second data packet indicates a peer inter-frame spacing shorter than said default inter-frame spacing, determining a longest inter-frame spacing from said peer inter-frame spacing and said minimum inter-frame spacing and transmitting a third packet using said longest inter-frame spacing as the inter-frame spacing shorter than the default inter-frame spacing; and
if said second data packet does not indicate a peer inter-frame spacing shorter than said default inter-frame spacing, transmitting said third packet using said default inter-frame spacing.

The third data packet could be any type of packet consistent with the predetermined protocol and need not be the next packet to be transmitted by the device. For example in some situations the peer device may not know whether the device has received the second packet and therefore whether or when it will implement the reduced inter-frame spacing. In a set of embodiments therefore the device transmits an acknowledgement of the second packet using the default inter-frame spacing, prior to transmitting the third packet, which allows the peer device thereafter to implement the reduced IFS. The third packet specified in accordance with the invention transmitted by the device may not therefore be the first packet transmitted by the devices using the reduced IFS. However the Applicant has recognised that this may mean that the device has to listen for the next packet from the peer device without knowing whether the peer device has implemented the reduced IFS (e.g. because it does not know whether the peer device received its acknowledgement) and so has to have a longer listening window consistent with both the shorter and the default IFS. This may increase power consumption.

In another set of embodiments therefore the second or third packet comprises timing information indicating a time for the device or peer device to implement the reduced IFS. This may be beneficial in avoiding the additional listening window set out above, as the device is able to know in advance when the peer device will implement the new IFS. The timing information may comprise an event counter offset or an event number at which the device or peer device should implement the new IFS. In a set of embodiments the timing information indicates the beginning of a specific connection interval as marked by transmission of a packet from a designated device, e.g. the central device in a Bluetooth™ system to a peripheral device in a Bluetooth™ system.

In a set of embodiments the default inter-frame spacing is 150 μS. In a set of embodiments the predetermined communication protocol is one compatible with a Bluetooth™ protocol—e.g. Bluetooth™ Low Energy. For example in such embodiments the device is, apart from the indication of support for an inter-frame spacing shorter than said default inter-frame spacing, compatible with Bluetooth™ or Bluetooth™ Low Energy and can communicate with devices operating in accordance with Bluetooth™ or Bluetooth™ Low Energy which do not support the indication of support for an inter-frame spacing shorter than said default inter-frame spacing. The device specified herein could be a central device (with the peer device being a peripheral device) or vice versa. In other words the negotiation of a reduced IFS could be initiated by either the central or the peripheral device.

In a set of such embodiments the first data packet is a newly defined category of packet for Bluetooth™ or Bluetooth™ Low Energy which has a format similar to a Link Layer Control message as specified in Bluetooth™ or Bluetooth™ Low Energy.

In a set of embodiments the first data packet specified herein is transmitted after the device and the peer device have established a connection, e.g. as specified in the Bluetooth™ protocol, using the default inter-frame spacing.

### BRIEF DESCRIPTION OF THE DRAWINGS

Embodiments of the invention will now be described, by way of example only, with reference to the accompanying drawings in which:

FIG. 1 is a schematic diagram illustrating a typical radio communication system;

FIG. 2 is a flowchart illustrating a general process by which an IFS negotiation is performed in accordance with embodiments of the invention where a central radio device initiates the negotiation;

FIG. 3 is a flowchart illustrating a general process by which an IFS negotiation is performed in accordance with embodiments of the invention where a peripheral radio device initiates the negotiation;

FIG. 4 shows exemplary transmission/reception sequences between a central radio device and a peripheral radio device in accordance with an embodiment in which an IFS negotiation is initiated by the central device;

FIG. 5 is a more detailed timing diagram of the sequence shown in FIG. 4;

FIG. 6 shows exemplary transmission/reception sequences between a central radio device and a peripheral radio device in accordance with another embodiment in which an IFS negotiation is initiated by the central device;

FIG. 7 is a more detailed timing diagram of the sequence shown in FIG. 6;

FIG. 8 shows exemplary transmission/reception sequences in an embodiment where the peripheral device does not support IFS negotiation;

FIG. 9 shows exemplary transmission/reception sequences between a central radio device and a peripheral radio device in accordance with an embodiment in which an IFS negotiation is initiated by the peripheral device;

FIG. 10 shows exemplary transmission/reception sequences between a central radio device and a peripheral radio device in accordance with another embodiment in which an IFS negotiation is initiated by the peripheral device; and

FIG. 11 shows exemplary transmission/reception sequences in an embodiment where the peripheral device does not support IFS negotiation.

### DETAILED DESCRIPTION OF THE DRAWINGS

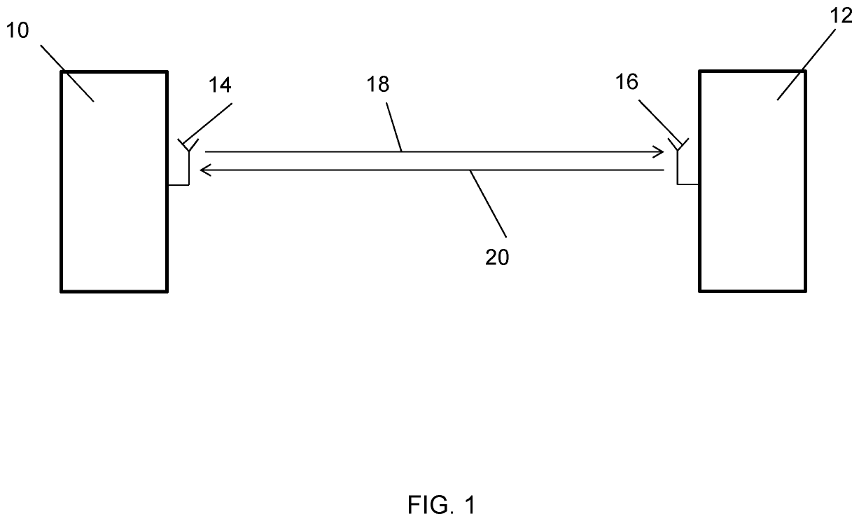

FIG. 1 shows a radio system comprising a central, or initiator, Bluetooth™ transceiver device 10, and a peripheral Bluetooth™, radio transceiver device 12. Hereafter, these will be referred to as the central device 10 and the peripheral device 12. The central device 10 comprises an antenna 14, and the peripheral device 12 comprises an antenna 16. As will be well understood by those skilled in the art, a number of standard modules such as processors, oscillators, filters, amplifiers, digital to analogue converters (DACs) and analogue to digital converters (ADCs) are provided in the radio transceivers 10 and 12 but the description of these is omitted for the sake of brevity.

FIG. 1 also shows the signal paths 18 and 20. Signal path 18 is from the central device 10 when acting as a transmitter through its respective antenna 14 to the peripheral device 12 when acting as a receiver through its antenna 16. Signal path is from the peripheral device 12 when acting as a transmitter through its antenna 16 to the central device 10 when acting as a receiver through its respective antenna 14. The transceivers 10 and 12 are largely configured to operate according to a Bluetooth™ protocol.

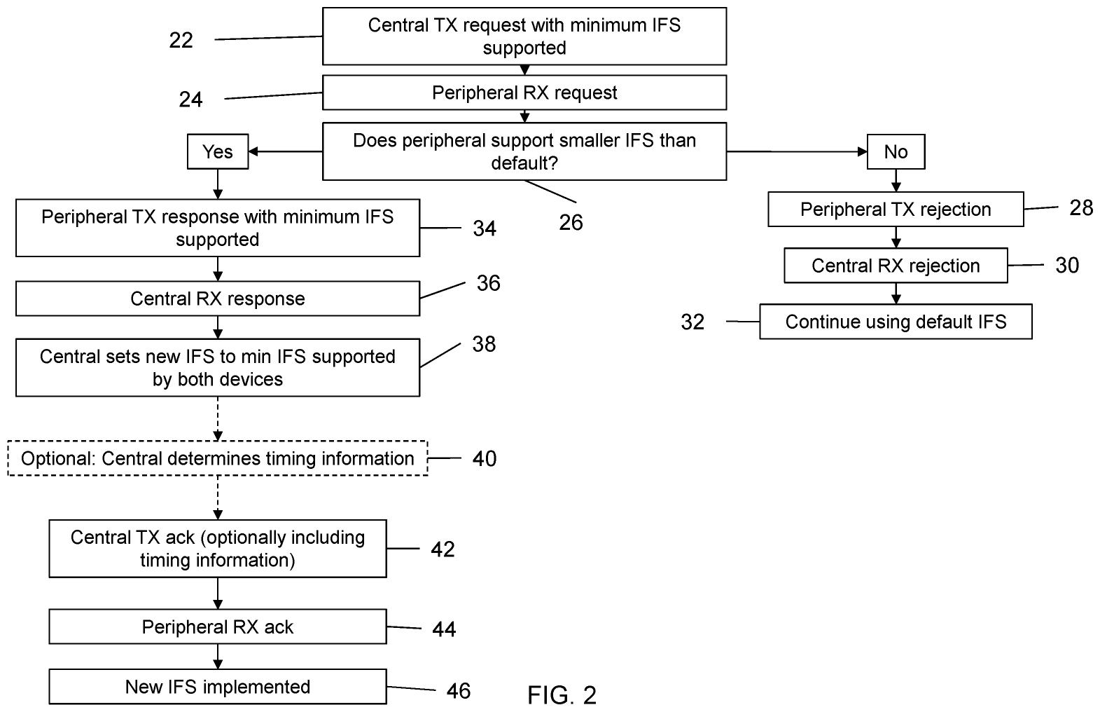

FIG. 2 is a flowchart illustrating a process in accordance with the invention by which the central device 10 and the peripheral device 12 negotiate an inter-frame spacing (IFS) change, where it is the central device 10 that initiates the negotiation. As used herein, the term inter-frame spacing (IFS) is used to describe the designated time allotted for the central device 10 and the peripheral device 12 to switch between a transmission mode of operation and a reception mode of operation. In order to maintain a connection between the two devices 10 and 12, the IFS used by both devices must be the same: while the central device 10 is in a transmitting mode of operation the peripheral device 12 must simultaneously be in a receiving mode of operation, and vice versa. The flowchart shown in FIG. 2 assumes that a Bluetooth™, connection has already been successfully formed between the central device 10 and the peripheral device 12. In a standard Bluetooth™ connection a default 150 μS IFS is specified.

At step 22, the central device 10 initiates the IFS negotiation process by transmitting a request message containing the minimum IFS that is supported by the central device 10 which is shorter than the default Bluetooth™ IFS of 150 μS. At step 24, the peripheral device 12 receives the request message transmitted by the central device 10. At step 26, the peripheral device 12 determines whether it is able to support an IFS shorter than the default Bluetooth™.

If the peripheral device 12 is not able to support an IFS shorter than the default IFS, it proceeds to step 28. At step 28, the peripheral device 12 transmits a rejection message indicating that the peripheral device 12 does not support a shorter IFS than the default IFS. At step 30, the central device 10 receives the rejection message transmitted by the peripheral device 12. Then, at step 32, the connection between the central device 10 and the peripheral device 12 continues using the default Bluetooth™ IFS.

If the peripheral device 12 is able to support an IFS shorter than the default IFS, it instead proceeds to step 34. At step 34, the peripheral device 12 transmits a response message. Contained within the response message is the minimum IFS that is supported by the peripheral device 12. At step 36, the central device 10 receives the response message transmitted by the peripheral device 12. At step 38, the central device 10 sets the new IFS to the minimum IFS that is supported by both the central device 10 and the peripheral device 12. Optionally the peripheral device could calculate this as well as it would know the capabilities of both devices. The minimum IFS that is supported by both the central device 10 and the peripheral device 12 is equal to the larger of: the minimum IFS supported by the central device 10, and the minimum IFS supported by the peripheral device 12.

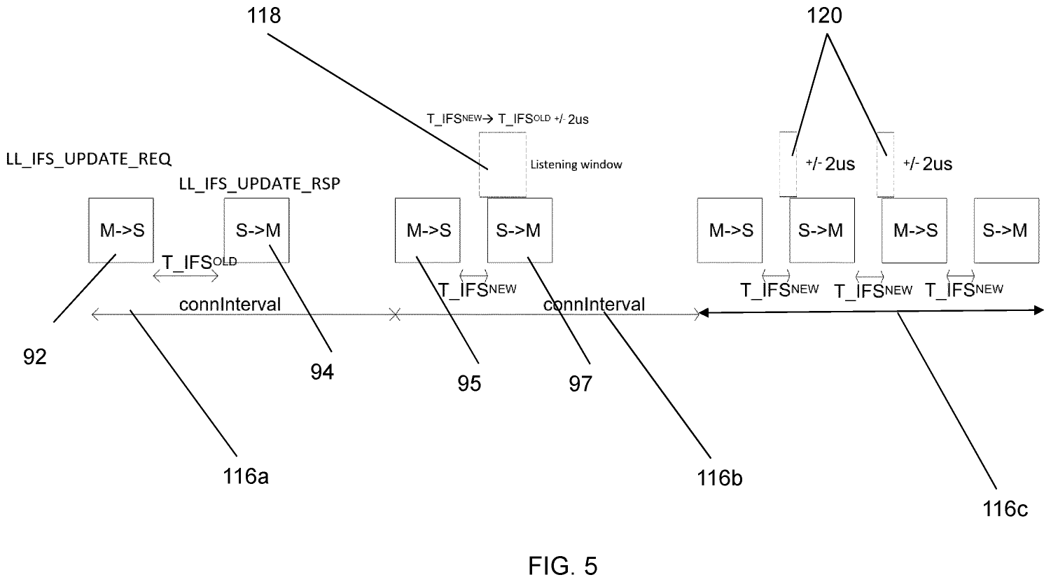

At optional step 40 present in some embodiments, the central device 10 determines timing information which indicates the time at which the central device 10 and peripheral device 12 should implement the new IFS. The timing information in this example comprises an event counter offset. As used herein, the term event is used to describe a connection event in which the central device 10 and peripheral device 12 are allocated specific windows in which to transmit/receive data. This is described in further detail with reference to FIG. 5. The event counter is an incrementing index that allows the central device 10 and peripheral device 12 to keep track of the number of connection events that have occurred during the connection between the two devices. The timing information in this example an offset to the current event counter—i.e. it indicates how many connection events should be performed with the default IFS before implementing the new IFS. For example, if the timing information is equal to +5, and the current event counter is n, then this indicates that the new IFS should be implemented when the event counter reaches n+5 (i.e. five connection events later).

At step 42, the central device 10 transmits an acknowledgement message to the peripheral device 12 which optionally includes the timing information determined at optional step 40.

At step 44, the peripheral device 12 receives the acknowledgement message transmitted by the central device 10. At step 46, in embodiments where optional timing information (determined at optional step 40) is included in the acknowledgement message transmitted by the central device 10 at step 42, the new IFS is implemented for all communications between the two devices 10 and 12 falling at or after the time indicated by the timing information while a connection is maintained between the two devices 10 and 12. In embodiments where no timing offset information is included in the acknowledgement message (i.e. the central device 10 did not perform optional step 40), then the central device 10 and the peripheral device 12 implement the new IFS for all communications subsequent to the peripheral device 12 receiving the acknowledgement message while a connection is maintained between the two devices 10 and 12.

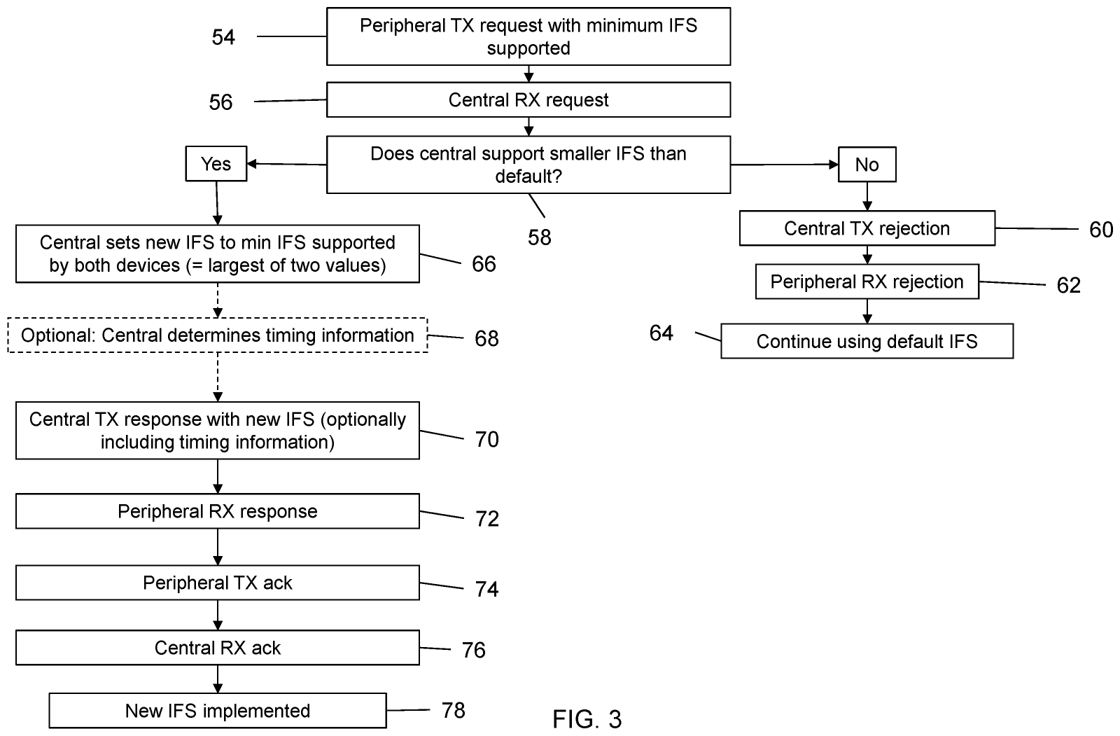

FIG. 3 is a flowchart illustrating the process by which the central device 10 and the peripheral device 12 negotiate an inter-frame spacing (IFS) change, where it is the peripheral device 12 that initiates the negotiation. The flowchart shown in FIG. 3 also assumes that a Bluetooth™ connection has already been successfully formed between the central device 10 and the peripheral device 12.

At step 54, the peripheral device 12 initiates the IFS negotiation process by transmitting a request message containing the minimum IFS that is supported by the peripheral device 12. At step 56, the central device 10 receives the request message transmitted by the peripheral device 12. At step 58, the central device 10 determines whether it is able to support an IFS shorter than the default Bluetooth™ IFS.

If the central device 10 is not able to support an IFS shorter than the default IFS, it proceeds to step 60. At step 60, the central device 10 transmits a rejection message indicating that the central device 10 does not support a shorter IFS than the default IFS. At step 62, the peripheral device 12 receives the rejection message transmitted by the central device 10. Then, at step 64, the central device 10 and the peripheral device 12 continue using the default Bluetooth™ IFS.

If the central device 10 is able to support an IFS shorter than the default IFS, it instead proceeds to step 66. At step 66, the central device 10 sets the new IFS to the minimum IFS that is supported by both the central device 10 and the peripheral device 12. The minimum IFS that is supported by both the central device 10 and the peripheral device 12 is equal to the larger of: the minimum IFS supported by the central device 10, and the minimum IFS supported by the peripheral device 12. At optional step 68 present in some embodiments, the central device 10 determines timing information which indicates the time at which the central device 10 and peripheral device 12 should implement the new IFS. The timing information in this example comprises an event counter offset, as described with reference to optional step 40 of FIG. 2.

At step 70, the central device 10 transmits a response message containing the new IFS that will be used, the response message optionally including the timing offset information determined at optional step 68. At step 72, the peripheral device 12 receives the response message transmitted by the central device 10. At step 74, the peripheral device 12 transmits an acknowledgement message, which is then received by the central device 10 at step 76. At step 78, in embodiments where optional timing offset information (determined at optional step 68) is included in the response message transmitted by the central device 10 at step 70, the new IFS is implemented for all communications between the two devices 10 and 12 falling at or after the time indicated by the timing offset information while a connection is maintained between the two devices 10 and 12. In embodiments where no timing offset information is included in the response message (i.e. the central device did not perform optional step 68), the central device 10 and the peripheral device 12 implement the new IFS for all communications subsequent to the central device 12 receiving the acknowledgement message transmitted by the peripheral device 12 at step 74 while a connection is maintained between the two devices 10 and 12.

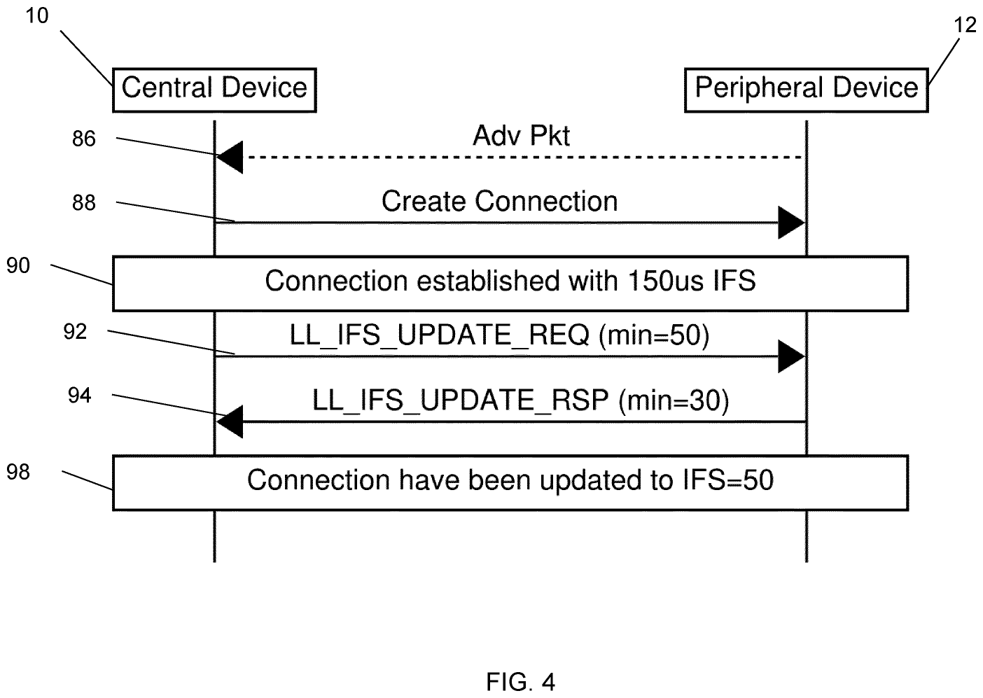

FIGS. 4, 6 and 8 show exemplary scenarios of transmission/reception sequences between the central device 10 and the peripheral device 12 in order to negotiate a new IFS for communications between the two devices 10 and 12, where it is the central device 10 that initiates the negotiation. In these Figures. the vertical axis represents the flow of time, from top to bottom. The horizontal arrows indicate packet transmissions. In these examples, the central device 10 and the peripheral device 12 are configured to communicate under the Bluetooth Low Energy (BLE) protocol.

Turning to FIG. 4, initially the peripheral device 12 transmits a standard BLE advertising packet 86 in order to indicate its presence to nearby devices. The advertising packet 86 is transmitted ‘in the dark’—i.e. the peripheral device 12 transmits the packet without prior knowledge of another device in its vicinity being able to receive the packet. In this scenario, the central device 10 successfully receives the advertising packet 86. The central device 10 then transmits a connection request packet 88 to the peripheral device 12. At point 90, after successful reception of the connection request packet 88 by the peripheral device 12, a connection is established between the central device 10 and the peripheral device 12 with an IFS of 150 μs—the default IFS under the BLE protocol.

Next, the central device 10 transmits an LL_IFS_UPDATE_REQ packet 92 (equivalent to a request message as described with reference to steps 22 and 24 of FIG. 2) to the peripheral device 12. In this packet, the central device 10 requests that the IFS used for the connection be changed to a shorter value. In this example, the minimum IFS that the central device 10 supports is 50 μs which is indicated in the LL_IFS_UPDATE_REQ packet 92. The LL_IFS_UPDATE_REQ packet is a newly defined category of packet for use with a modified version of BLE, but has a similar format to the pre-existing link layer control message within BLE.

In this example, the minimum IFS supported by the peripheral device 12 is 30 μs. After receiving the LL_IFS_UPDATE_REQ packet 92, the peripheral device 12 transmits an LL_IFS_UPDATE_RSP packet 94 (equivalent to a response message as described with reference to steps 34 and 36 of FIG. 2) to the central device 10. In this packet, the peripheral device 12 indicates that the minimum IFS it is able to support is 30 μs. The LL_IFS_UPDATE_RSP packet 94 is also a newly defined category of packet for use with BLE, but has a similar format to the pre-existing BLE link layer control message.

In this embodiment, after receiving the LL_IFS_UPDATE_RSP packet 94 from the peripheral device 12, both devices 10, 12 are able to determine the minimum IFS that is supported by both devices 10 and 12 to be 50 μs, as 50 μs>30 μs. Thus at point 98 the central device 10 and the peripheral device 12 implement the new IFS of 50 μs. However, as will be described below with reference to FIG. 5, there is some ambiguity as to whether the peripheral device will implement the new IFS in the next connection interval.

FIG. 5 shows a more detailed timing diagram relating to the exchange shown in FIG. 4. As will be seen, a first connection interval 116a starts with transmission of the LL_IFS_UPDATE_REQ packet 92 from the central device 10 to the peripheral device 12 (equivalently from the master ‘M’ device to the slave ‘S’ device as indicated). After a delay equal to the default IFS (T_IFS^{old}) the master device transmits the LL_IFS_UPDATE_RSP packet 94. Under the BLE protocol, the timing of transmission and reception of each packet by a transceiver has a tolerance of ±2 μs. This means, therefore, that the master device must listen for the start of the response packet 94 during a window of 2 μs on either side of the expected timing based on the IFS, i.e. total listening window of 4 μs in addition to the actual packet length.

The next connection interval 116b also starts with transmission of a packet 95 from the master to the slave. However when listening for the response 97 from the slave, the master does not know whether the slave has yet implemented the reduced IFS. It must therefore listen over an extended listening window 118 for the beginning of the transmission. This window begins at what would be the expected time if the new IFS has been implemented minus 2 μs to the end of the time at which transmission would take place under the old, default IFS plus 2 μs. This therefore requires the master to have its receiver powered for longer than would otherwise be the case which results in some increase in power consumption.

Once the master has received the packet 97 from the slave however it knows that the slave will have implemented the new IFS by the time of the next connection interval 116c even if it had not done so in the preceding connection interval 116b. This allows the master to revert to the shorter listening window 120 of +/−2 μs. It will be noted that once the shorter IFS has been implemented by both devices it will be applied to transmissions in both directions as shown in the third connection interval 116c. Since the time delay between consecutive packet transmissions is reduced, the effective data rate which can be achieved may be significantly enhanced. For example it may be possible to have extra packet exchanges in a connection interval as indicated schematically by the two exchanges (four packet transmissions) in the third connection interval 116c as compared to the single exchange in first and second connection intervals 116a, 116b.

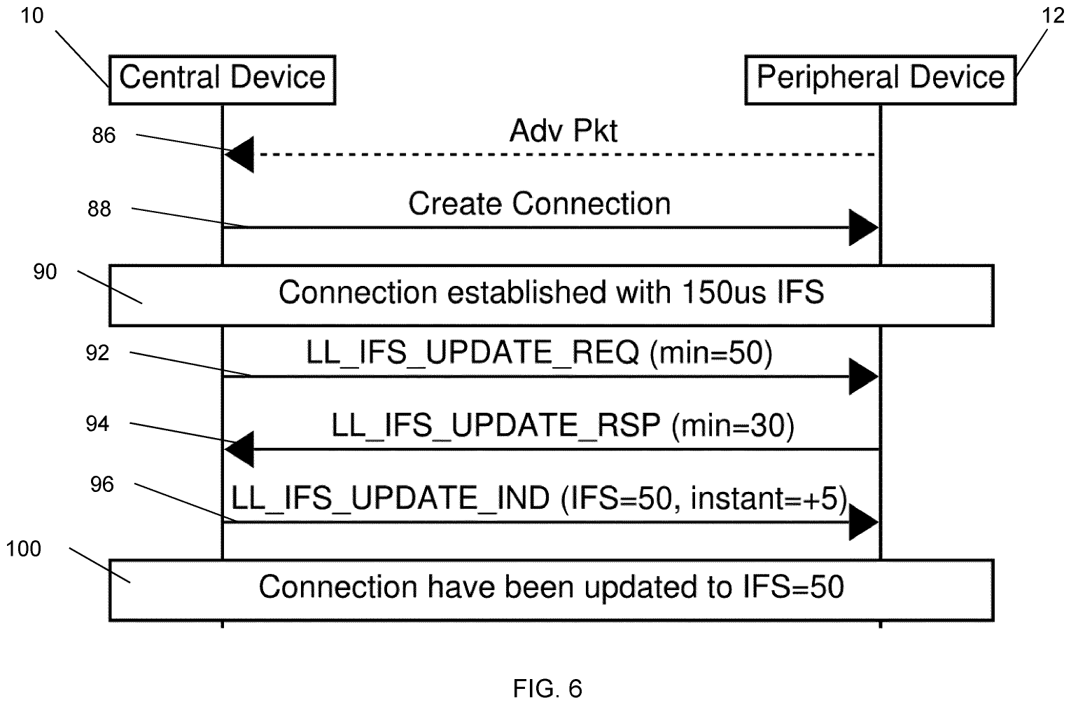

FIG. 6 shows another embodiment showing a transmission/reception sequence between the central device 10 and the peripheral device 12 in order to negotiate a new IFS. In this example, steps 86, 88, 90, 92 and 94 are identical to those described with reference to FIG. 4, with the central device 10 initiating the IFS negotiation. However, after the central device 10 receives the LL_IFS_UPDATE_RSP packet 94, it calculates the new IFS to be used (50 μs which is the lowest time both devices can support). In this case the peripheral device does not need to make this determination. The central device 10 then transmits an LL_IFS_UPDATE_IND packet 96 (equivalent to an acknowledgement message as described with reference to steps 42 and 44 of FIG. 2) to the peripheral device 12. The LL_IFS_UPDATE_IND packet is also a newly defined category with a similar format to the pre-existing BLE link layer control message.

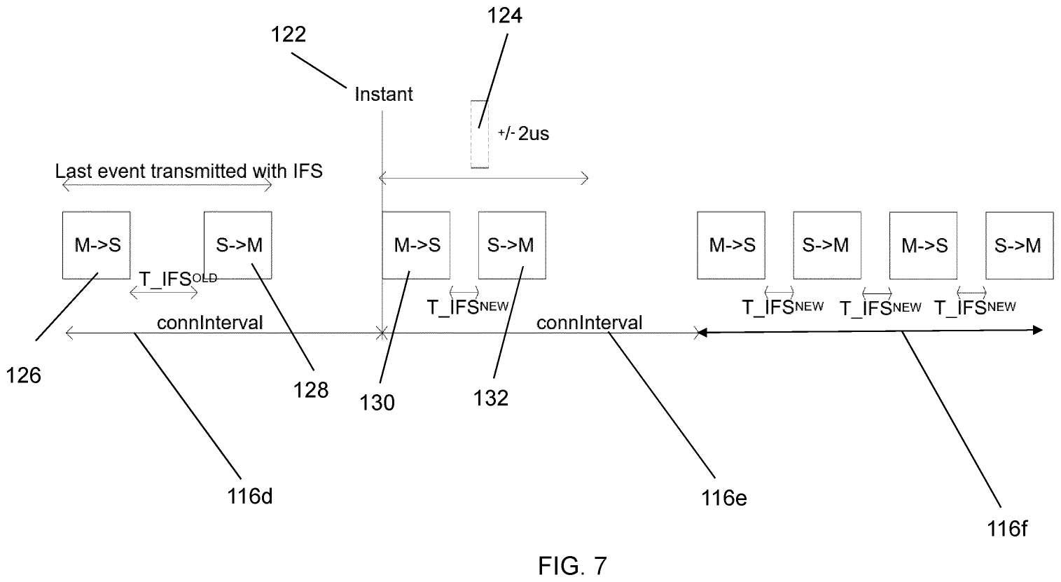

In the LL_IFS_UPDATE_IND packet 96, the central device 10 indicates to the peripheral device 12 what the new IFS will be (50 μs), and timing information (event counter offset) indicating the time at which the new IFS should be implemented. In this example the timing information specifies that the ‘instant’ for implementing the change is the current connection interval event counter+5, meaning that the new IFS should be implemented five connection events later. Once the peripheral device 12 has received the LL_IFS_UPDATE_IND packet 96 from the central device 10, the central device 10 and the peripheral device 12 implement the new IFS of 50 μs at point 100 at the time indicated by the timing information contained within the LL_IFS_UPDATE_IND packet 96 as described with reference to FIG. 7.

FIG. 7 shows a more detailed timing diagram showing the effect of the exchange shown in FIG. 6. FIG. 7 thus shows in more detail the planned implementation of the switch from the old (or default) IFS to the new IFS for both the central device 10 (equivalently the master ‘M’ device) and the peripheral device 12 (equivalently the slave ‘S’ device). After the LL_IFS_UPDATE_IND packet 96 is transmitted as shown in FIG. 6 (during a connection interval having an event counter value ‘n’), three more connection intervals take place which are not shown. The first connection interval 116d shown in FIG. 7 (with event counter n+4) is the last to use the default IFS. This connection interval 116d starts with a packet transmission 126 from the master to the slave, followed by a packet transmission 128 from the slave to the master after a delay equal to the default IFS (T_IFS^{old}).

The next connection interval 116e (with event counter of n+5) is the ‘instant’ 122 which is the connection interval previously specified in the LL_IFS_UPDATE_IND packet 96 and begins with transmission of a packet 130 from the master to the slave. Since the master has instructed the slave when to implement the new IFS (i.e. at event counter n+5) in advance, it does not need an extended listening window as described above with reference to FIG. 5; it can instead employ a standard window 124 of +/−2 μs thereby saving power relative to the arrangement of FIGS. 4 and 5, as it knows that the peripheral device 12 will use the new IFS in the connection interval 116e.

As before, in the third connection interval 116f and any subsequent ones, the new IFS allows the time delay between consecutive packet transmissions to be reduced, enabling extra packet exchanges within each connection interval which significantly enhances the effective data rate which can be achieved.

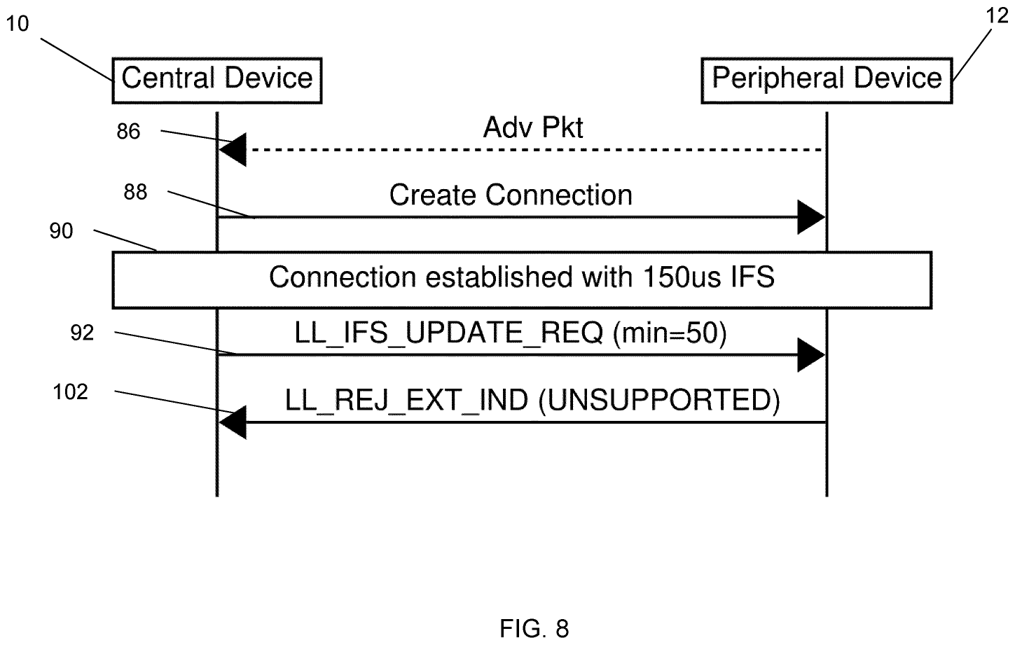

FIG. 8 shows another possible sequence to negotiate a new IFS. Again, steps 86, 88, 90 and 92 are identical to those described with reference to FIG. 4, with the central device 10 initiating the IFS negotiation. However, after the peripheral device 12 receives the LL_IFS_UPDATE_REQ packet 92, it does not transmit an LL_IFS_UPDATE_RSP packet as described with reference to FIG. 4. Instead, the peripheral device 12 determines that it does not support a shorter IFS than the default specified in BLE and therefore transmits an LL_REJ_EXT_IND packet 102 (equivalent to a rejection message as described with reference to steps 28 and 30 of FIG. 2) to the central device 10. The central device 10 and the peripheral device 12 then continue using the default IFS of 150 μs.

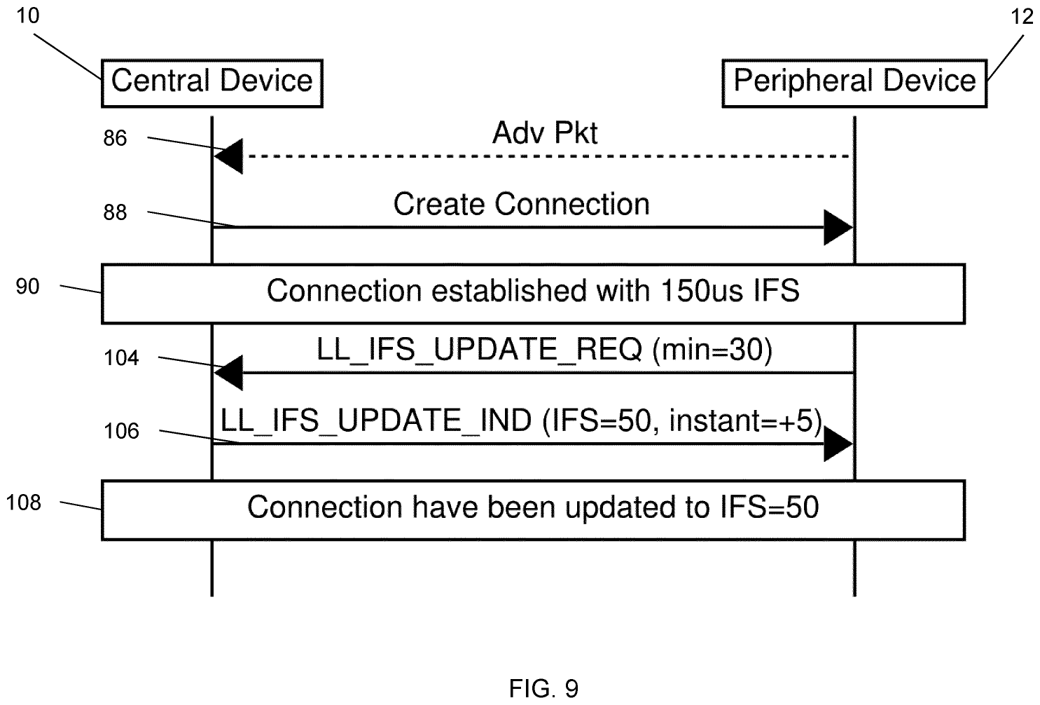

FIGS. 9 to 11 show exemplary scenarios of transmission/reception sequences between the central device 10 and the peripheral device 12 in order to negotiate a new IFS for communications between the two devices 10 and 12, where it is the peripheral device 12 that initiates the negotiation.

In FIG. 9 steps 86, 88 and 90 are identical to those described with reference to FIG. 4, with a connection being established at point 90 between the central device 10 and the peripheral device 12.

Next, the peripheral device 12 transmits an LL_IFS_UPDATE_REQ packet 104 (a request message) to the central device 10. In this packet, the peripheral device 12 requests that the IFS used for the connection be changed to a shorter value. In this example, the minimum IFS that the peripheral device 12 supports is 30 μs, and the peripheral device 12 indicates this in the LL_IFS_UPDATE_REQ packet 104.

In this example, the minimum IFS supported by the central device 10 is 50 μs. After receiving the LL_IFS_UPDATE_REQ packet 104, the central device 10 determines the minimum IFS that is supported by both devices 10 and 12 to be 50 μs, as 50 μs>30 μs, and timing information (event counter offset) indicating the time at which the new IFS should be implemented, as explained above with reference to FIGS. 6 and 7. The central device 10 then transmits an LL_IFS_UPDATE_IND packet 106 (equivalent to a response message as described with reference to steps 70 and 72 of FIG. 3) to the peripheral device 12 at step 106. In the LL_IFS_UPDATE_IND packet 106, the central device 10 indicates to the peripheral device 12 what the new IFS will be (50 μs), and the time at which the new IFS should be implemented. Once the peripheral device 12 has received the LL_IFS_UPDATE_IND packet from the central device 10, the central device 10 and the peripheral device 12 implement the new IFS of 50 μs at step 108 in a similar manner to that shown in FIG. 7, at the time indicated by the timing information contained within the LL_IFS_UPDATE_IND packet 106.

FIG. 8 shows another possible scenario of a transmission/reception sequence between the central device 10 and the peripheral device 12 in order to negotiate a new IFS. In this example, steps 86, 88, 90 and 104 are identical to those described with reference to FIG. 7.

In this embodiment, the minimum IFS supported by the central device 10 is 50 μs. After receiving the LL_IFS_UPDATE_REQ packet 104, the central device 10 determines the minimum IFS that is supported by both devices to be 50 μs, as 50 μs>30 μs. The central device 10 then simply transmits an LL_IFS_UPDATE_RSP packet 110 (equivalent to a response message as described with reference to steps 70 and 72 of FIG. 3), indicating that the new IFS will be 50 μs. At point 112, the central device 10 and the peripheral device 12 implement the new IFS of 50 μs. This may or may not be first implemented during the next connection interval as explained above with reference to FIG. 5, but if not will be implemented in the connection interval after that.

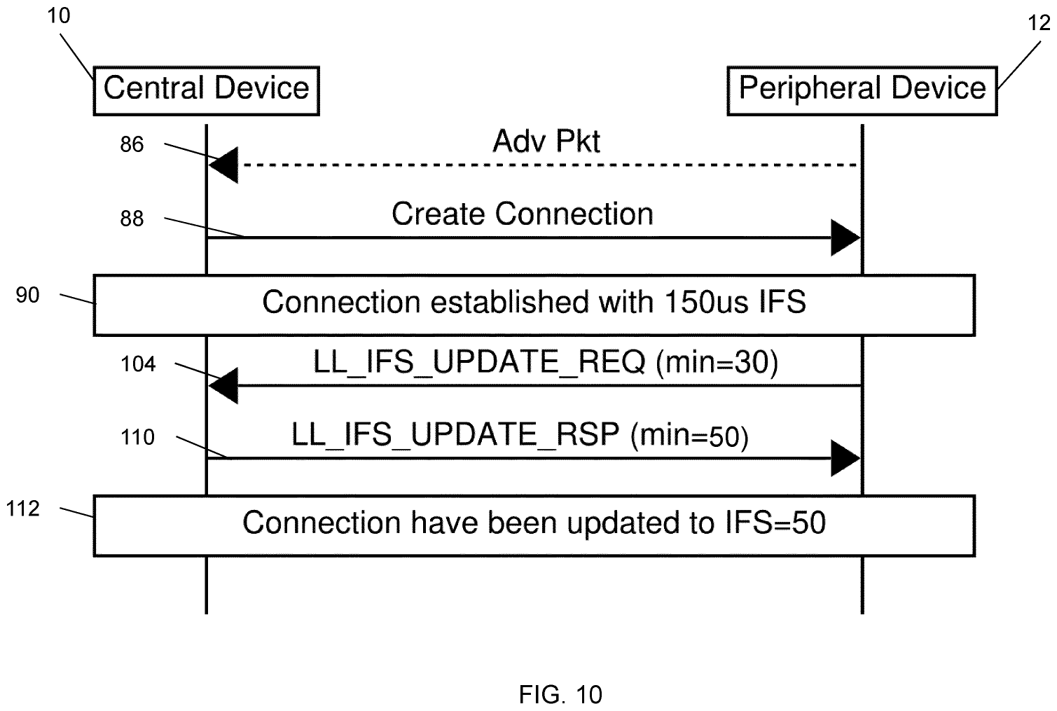

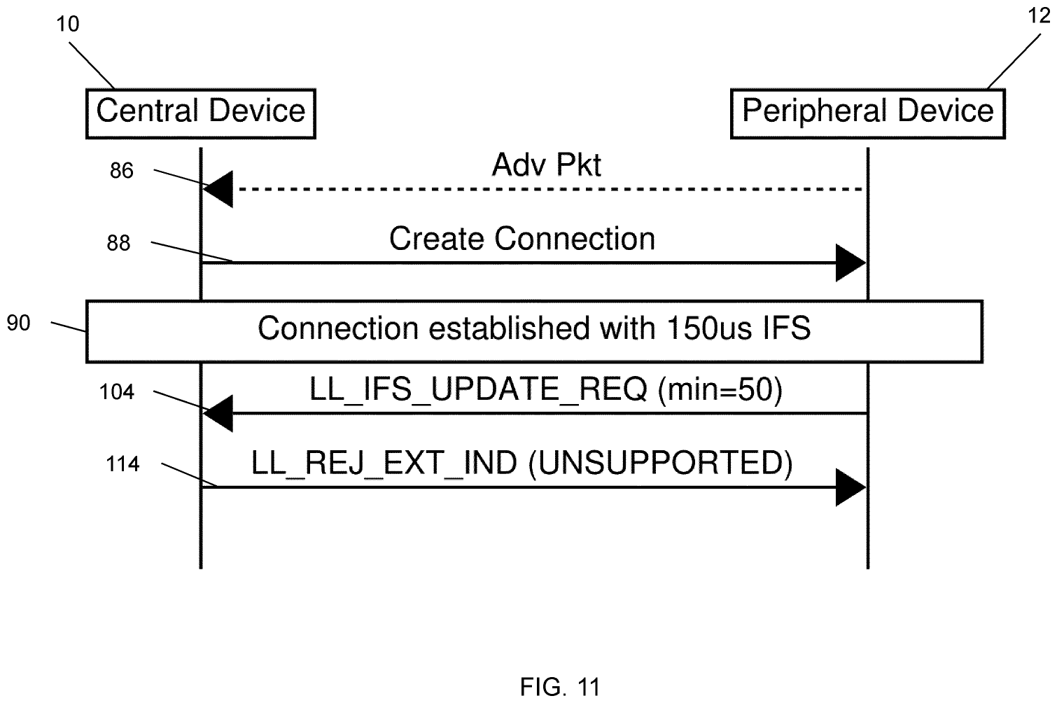

FIG. 11 shows another possible scenario of a transmission/reception sequence between the central device 10 and the peripheral device 12 in order to negotiate a new IFS. In this example, steps 86, 88, 90 and 104 are identical to those described with reference to FIG. 10. However, after the central device 10 receives the LL_IFS_UPDATE_REQ packet 104, it does not transmit an LL_IFS_UPDATE_IND packet. Instead, the central device 10 determines that it does not support a shorter IFS than the default specified BLE. The central device 10 therefore transmits an LL_REJ_EXT_IND packet 114 (equivalent to a rejection message as described with reference to steps 60 and 62 of FIG. 3) to the peripheral device 12 and so the central device 10 and the peripheral device 12 then continue using the default IFS of 150 μs.

1. A method of operating a digital radio transmitter device in accordance with a predetermined communication protocol defining a default inter-frame spacing, the digital radio transmitter device having a minimum inter-frame spacing shorter than said default inter-frame spacing, the method comprising:
transmitting a first data packet indicating that the digital radio transmitter device is able to support an inter-frame spacing shorter than said default inter-frame spacing;
receiving a second data packet from a peer device after said default inter-frame spacing;
if said second data packet indicates that said peer device is able to support an inter-frame spacing shorter than said default inter-frame spacing, transmitting a third data packet using a first inter-frame spacing shorter than said default inter-frame spacing; and
if said second data packet does not indicate that said peer device is able to support an inter-frame spacing shorter than said default inter-frame spacing, transmitting said third data packet using said default inter-frame spacing.

2. The method as claimed in claim 1 wherein the first data packet comprises information relating to said minimum inter-frame spacing.

3. The method as claimed in claim 1 wherein the second data packet indicates a peer inter-frame spacing shorter than said default inter-frame spacing.

4. The method as claimed in claim 1 comprising:
if said second data packet indicates a peer inter-frame spacing shorter than said default inter-frame spacing, determining a longest inter-frame spacing from said peer inter-frame spacing and said minimum inter-frame spacing and transmitting the third data packet using said longest inter-frame spacing as the first inter-frame spacing shorter than the default inter-frame spacing; and
if said second data packet does not indicate a peer inter-frame spacing shorter than said default inter-frame spacing, transmitting said third data packet using said default inter-frame spacing.

5. The method as claimed in claim 1 comprising the digital radio transmitter device transmitting an acknowledgement of the second data packet using the default inter-frame spacing, prior to transmitting the third data packet.

6. The method as claimed in claim 1 wherein the second or third data packet comprises timing information indicating a time for the digital radio transmitter device or peer device to implement the first inter-frame spacing.

7. The method as claimed in claim 6 wherein the timing information comprises an event counter offset or an event number at which the digital radio transmitter device or peer device should implement the first inter-frame spacing.

8. The method as claimed in claim 6 wherein the timing information indicates the beginning of a specific connection interval.

9. The method as claimed in claim 1 wherein the predetermined communication protocol is one compatible with a Bluetooth™ protocol.

10. The method as claimed in claim 1 comprising transmitting the first data packet after the digital radio transmitter device and the peer device have established a connection using the default inter-frame spacing.

11. A computer readable medium comprising instructions configured to cause a digital radio transmitter device to operate in accordance with the method as claimed in claim 1.

12. A digital radio transmitter device configured to operate in accordance with a predetermined communication protocol defining a default inter-frame spacing, the digital radio transmitter device having a minimum inter-frame spacing shorter than said default inter-frame spacing, wherein the digital radio transmitter device is configured to:
transmit a first data packet indicating that the digital radio transmitter device is able to support an inter-frame spacing shorter than said default inter-frame spacing;
receive a second data packet from a peer device after said default inter-frame spacing;
if said second data packet indicates that said peer device is able to support an inter-frame spacing shorter than said default inter-frame spacing, transmit a third data packet using a first inter-frame spacing shorter than said default inter-frame spacing; and
if said second data packet does not indicate that said peer device is able to support an inter-frame spacing shorter than said default inter-frame spacing, transmit said third data packet using said default inter-frame spacing.

13. The digital radio transmitter device as claimed in claim 12 wherein the first data packet comprises information relating to said minimum inter-frame spacing.

14. The digital radio transmitter device as claimed in claim 12 wherein the second data packet indicates a peer inter-frame spacing shorter than said default inter-frame spacing

15. The digital radio transmitter device as claimed in claim 12 configured:
if said second data packet indicates a peer inter-frame spacing shorter than said default inter-frame spacing, to determine a longest inter-frame spacing from said peer inter-frame spacing and said minimum inter-frame spacing and to transmit the third data packet using said longest inter-frame spacing as the first inter-frame spacing shorter than the default inter-frame spacing; and
if said second data packet does not indicate a peer inter-frame spacing shorter than said default inter-frame spacing, to transmit said third data packet using said default inter-frame spacing.

16. The digital radio transmitter device as claimed in claim 12 configured to transmit an acknowledgement of the second data packet using the default inter-frame spacing, prior to transmitting the third data packet.

17. The digital radio transmitter device as claimed in claim 12 wherein the second or third data packet comprises timing information indicating a time for the digital radio transmitter device or peer device to implement the first inter-frame spacing.

18. The digital radio transmitter device as claimed in claim 17 wherein the timing information comprises an event counter offset or an event number at which the digital radio transmitter device or peer device should implement the first inter-frame spacing.

19. The digital radio transmitter device as claimed in claim 17 wherein the timing information indicates the beginning of a specific connection interval.

20. The digital radio transmitter device as claimed in claim 12 wherein the predetermined communication protocol is one compatible with a Bluetooth™ protocol.

21. The digital radio transmitter device as claimed in claim 12 configured to transmit the first data packet after the digital radio transmitter device and the peer device have established a connection using the default inter-frame spacing.
